(19) United States
(12) Patent Application Publication
(10) Pub. No.: US 2023/0133060 A1
(43) Pub. Date: May 4, 2023

(54) RELAY CONTROL METHOD ANDE SYSTEM, ELECTRONIC DEVICE, AND STORAGE MEDIUM

(71) Applicant: SPREADTRUM COMMUNICATIONS (SHANGHAI) CO., LTD., Shanghai (CN)

(72) Inventor: Xing LIU, Shanghai (CN)

(21) Appl. No.: 17/791,642

(22) PCT Filed: Feb. 8, 2021
(86) PCT No.: PCT/CN2021/076068

§ 371 Date: Dec. 30, 2022

(30) Foreign Application Priority Data
Jan. 10, 2020 (CN) 202010027627.1

(51) Int. Cl. H04B 7/155; H04W 40/22

(52) U.S. Cl. CPC H04B 7/155; H04W 40/22

(57) ABSTRACT

Disclosed are a relay control method and system, an electronic device, and a storage medium. The method includes: receiving data sent by a first terminal device; and determining whether to forward the data based on a preset rule.

### CROSS REFERENCE TO RELATED APPLICATION

This is the U.S. national stage of application No. PCT/CN2021/076068, filed on Feb. 8, 2021. Priority under 35 U.S.C. § 119(a) and 35 U.S.C. § 365(b) is claimed from Chinese Application No. 202010027627.1, filed Jan. 10, 2020, the disclosure of which is also incorporated herein by reference.

### TECHNICAL FIELD

The present disclosure generally relates to communication technology field, and more particularly, to a relay control method and system, an electronic device, and a storage medium.

### BACKGROUND

In a process of traditional data transmission, as a signal continues to attenuate with a transmission distance during the transmission process, and when the signal attenuates to a certain extent, data sent by a sender cannot be successfully received by a receiver. However, some services need to transmit data within a larger coverage zone. Therefore, to enable farther receivers to successfully receive the data, it is necessary to adopt some coverage enhancement methods, such as increasing a sending power of the sender or repeating transmission of a same block for many times, so that the receiver can combine the data to get a combined gain. Another way is to forward through a base station. At present, a way of forwarding data through a relay is provided as follows. When the sender sends data to a long-distance receiver, the data is first sent to the base station, and the base station determines whether its transmission power reaches a certain power value, and if it is, the base station sends the data to the receiver.

### SUMMARY

Embodiments of the present disclosure provide a relay control method and system, an electronic device, and a storage medium, to improve a data transmission rate and transmission efficiency and reduce transmission cost.

In an embodiment of the present disclosure, a relay control method is provided, applied to a relay and including: receiving data sent by a first terminal device; and determining whether to forward the data based on a preset rule.

In an embodiment of the present disclosure, an electronic device is provided, including a memory, a processor, and computer instructions stored in the memory and capable of running on the processor, wherein when the processor executes the computer instructions, the above method is performed.

In an embodiment of the present disclosure, a computer-readable storage medium having computer instructions stored therein is provided, wherein when the computer instructions are executed by a processor, the above method is performed.

### BRIEF DESCRIPTION OF THE DRAWINGS

FIG. 1 is a flow chart of a relay control method according to an embodiment;

FIG. 2 is a partial flow chart of a relay control method according to an embodiment;

FIG. 3 is a flow chart of 202 in the relay control method as shown in FIG. 2;

FIG. 4 is a diagram of zones in the relay control method as shown in FIG. 2;

FIG. 5 is a partial flow chart of a relay control method according to an embodiment;

FIG. 6 is a flow chart of controlling a number of times of forwarding in the relay control method as shown in FIG. 5;

FIG. 7 is a partial flow chart of a relay control method according to an embodiment;

FIG. 8 is a block diagram of a relay control system according to an embodiment;

FIG. 9 is a block diagram of a relay control system according to an embodiment;

FIG. 10 is a block diagram of a relay control system according to an embodiment;

FIG. 11 is a block diagram of a relay control system according to an embodiment; and

FIG. 12 is a structural diagram of an electronic device according to an embodiment.

### DETAILED DESCRIPTION

The present disclosure is further illustrated below by means of embodiments, but is not limited to the scope of the embodiments. And numbers of steps in the following embodiments of a relay control method in the present disclosure are only for marking different steps, and do not represent a specific execution sequence. Different steps may be executed with reference to the step sequences in the following embodiments of the present disclosure. Alternatively, the sequence of the steps in each embodiment may be adjusted according to actual requirements. For example, the sequence of different steps may be reversed, or different steps may be executed simultaneously. Those skilled in the art could understand that the adjustment of the sequence of the steps in the following embodiments should not affect normal implementation of the relay control method.

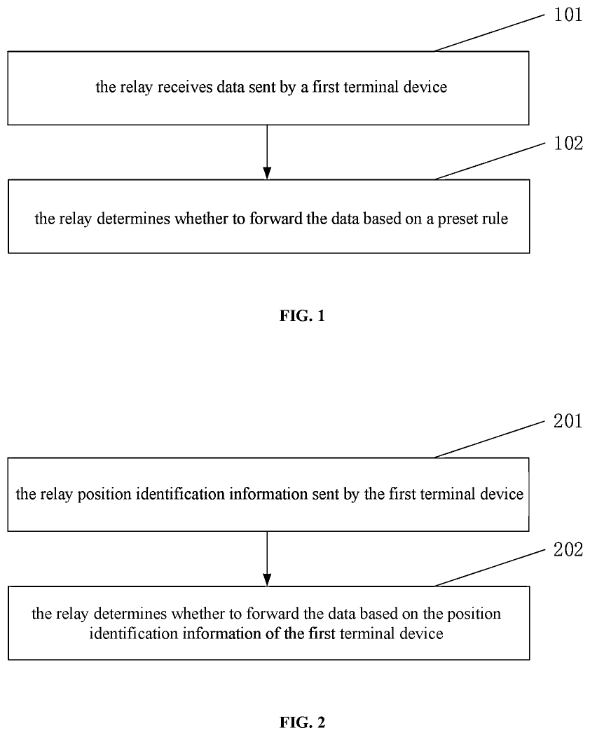

An embodiment of the present disclosure provides a relay control method, applied to a relay and including 101 and 102 as shown in FIG. 1.

In 101, the relay receives data sent by a first terminal device.

In 102, the relay determines whether to forward the data based on a preset rule.

In some embodiments, the first terminal device may be a sender or a relay.

In some embodiments, the relay may be a terminal. The terminal in the embodiments of the present disclosure may refer to various forms of UE, access terminal, user unit, user station, Mobile Station (MS), remote station, remote terminal, mobile equipment, user terminal, terminal equipment, wireless communication equipment, user agent or user device. The terminal equipment may further be a cellular phone, a cordless phone, a Session Initiation Protocol (SIP) phone, a Wireless Local Loop (WLL) station, a Personal Digital Assistant (PDA), a handheld device with a wireless communication function, a computing device or other processing devices connected to a wireless modems, an in-vehicle device, a wearable device, a terminal equipment in the future 5G network, or a terminal equipment in a future evolved Public Land Mobile Network (PLMN), which is not limited in the embodiments of the present disclosure.

In the embodiments, the received data is directly forwarded through the terminal device without a base station, which improves a rate and efficiency of data transmission, and increases resource utilization of a communication device.

An embodiment of the present disclosure provides a relay control method, which makes improvement on the method as shown in FIG. 1. As illustrated in FIG. 2, the method further includes 201 and 202.

In 201, the relay position identification information sent by the first terminal device.

In 202, the relay determines whether to forward the data based on the position identification information of the first terminal device. The position identification information indicates a position of the first terminal device. In this embodiment, 102 is realized by 202.

It could be understood that 201 may be performed before 101 or after 101, or simultaneously with 101.

The position identification information may be obtained from received control information, such as Sidelink Control Information (SCI), Medium Access Control (MAC), or Control Element (CE).

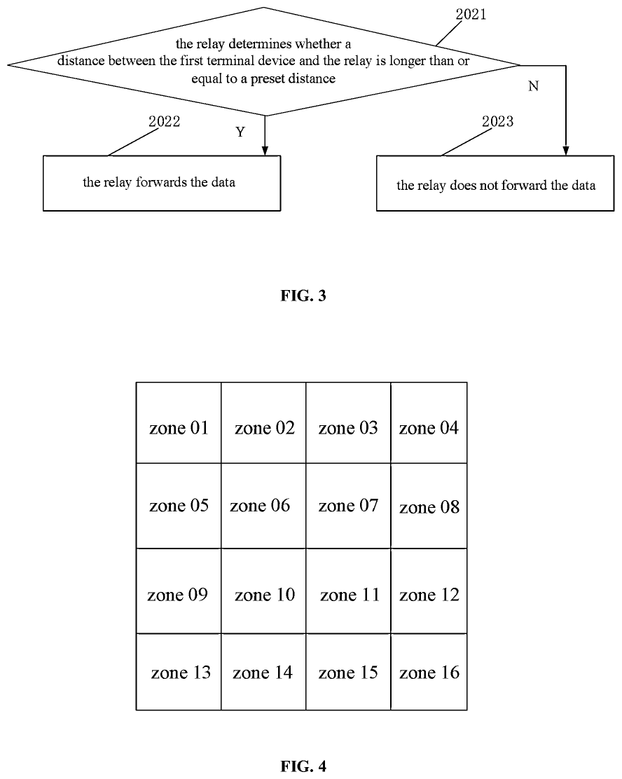

As shown in FIG. 3, 202 may include 2021, 2022 and 2023.

In 2021, the relay determines whether a distance between the first terminal device and the relay is longer than or equal to a preset distance, and if yes, 2022 is performed. Optionally, if no, 2023 is performed.

In 2022, the relay forwards the data.

In 2023, the relay does not forward the data.

Alternatively, 2022 is performed merely when the distance between the first terminal device and the relay is longer than the preset distance. Optionally, when the distance between the first terminal device and the relay is shorter than or equal to the preset distance, 2023 is performed. Either of the two alternative solutions for 2021 may be performed according to an actual situation.

In some communication technologies, such as Vehicle to X (V2X, information exchange between vehicles and the outside world), there is a concept of zone. A zone is a space defined by length, width and a reference coordinate point. Each zone has its own identification, and a position of a zone can be found through the corresponding identification. In this embodiment, to shorten length of control information carrying the position identification information, the position of the first terminal device may be represented by the zone identification information which indicates a position of the zone where the first terminal device is located. It should be understood that a position of the relay may also be represented by zone identification information. FIG. 4 shows that a large geographical space is divided into 16 zones with identification from 01 to 16. Through the zones and the identification, position information of the terminal can be roughly obtained. For example, the position represented by the zone identified as 01 is longitude 80 and latitude 160, and the position represented by the zone identified as 10 is longitude 75 and latitude 155. If the first terminal device is located in the zone identified as 01, and the relay is located in the zone identified as 10, a distance between the first terminal device and the relay is a distance between longitude 80, latitude 160 and longitude 75, latitude 155.

In the embodiment, the position is obtained through the zone identifier to reduce a size of the transmitted position identification information, which not only reduces complexity of the control information, but also increases an information transmission rate and saves system resources.

To better understand the embodiment, a specific scenario is provided for detailed description.

A first terminal device (either a relay or a sender) sends data information to a second terminal device (a relay), and the data information is associated with control information which carries position identification information representing the position of the first terminal device, that is, the position is zone 15. After receiving the data information and the control information associated with the data information sent by the first terminal device, the second terminal device determines whether a distance between its position, i.e., the zone 14, and the first terminal device is longer than or equal to a preset distance, and if yes, continues to forward the received data to a following terminal device. It should be understood that the following terminal device may be either a receiver or a relay.

In the embodiments of the present disclosure, data is directly forwarded through the relay without a base station, which improves a rate and efficiency of data transmission. In addition, it is determined whether the data needs to be forwarded based on the distance between the first terminal device and the relay, which avoids a conflict between relays due to a close distance and a waste of resources caused by multiple relays with a close distance forwarding the same data, thereby improving a gain of forwarding and resource utilization.

An embodiment of the present disclosure provides a relay control method, which makes improvement on the method as shown in FIG. 1, where 102 may include determining whether to forward the data based on a number of forwarding times of the data.

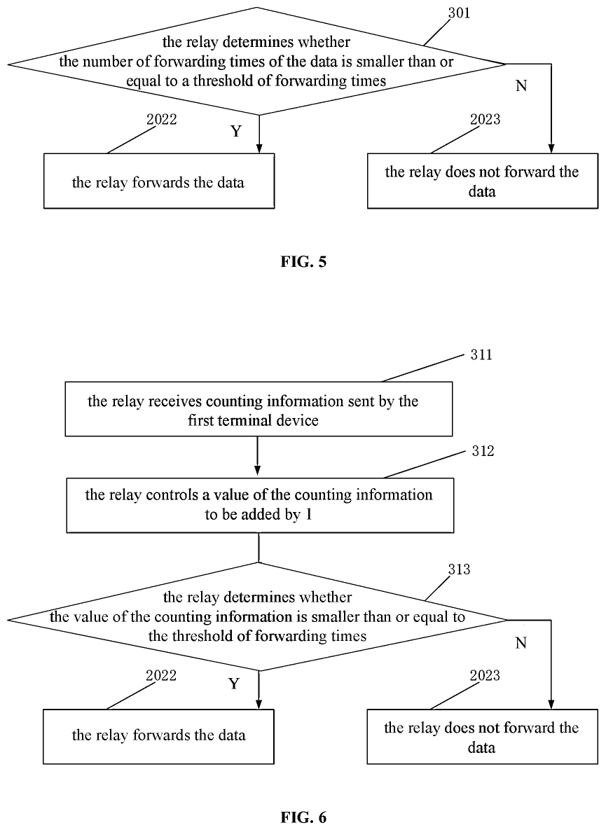

As shown in FIG. 5, the above step may include 301.

In 301, the relay determines whether the number of forwarding times of the data is smaller than or equal to a threshold of forwarding times, and if yes, 2022 is performed. Optionally, if no, 2023 is performed.

Alternatively, 2022 may be performed only when the number of forwarding times of the data is smaller than the threshold of forwarding times. Optionally, when the number of forwarding times of the data is greater than or equal to the threshold of forwarding times, 2023 is performed. Either of the two alternative solutions may be performed according to an actual situation.

In this embodiment, after 101 or while performing 101, the control of the number of forwarding times may be realized through specific steps as shown in FIG. 6.

In 311, the relay receives counting information sent by the first terminal device.

In 312, the relay controls a value of the counting information to be added by 1.

In 313, the relay determines whether the value of the counting information is smaller than or equal to the threshold of forwarding times, and if yes, 2022 is performed. Optionally, if no, 2023 is performed.

The counting information is used for representing the number of forwarding times of the data. Alternatively, 2022 may be performed only when the value of the counting information is smaller than the threshold of forwarding times. Optionally, 2023 may be performed when the value of the counting information is greater than or equal to the threshold of forwarding times. Either of the two alternative solutions may be performed according to an actual situation.

Alternatively, in some embodiments, 312 may be controlling the value of the counting information to be subtracted by 1, and 313 may be determining whether the value of the counting information is greater than or equal to the threshold of forwarding times. If yes, 2022 is performed. Optionally, if no, 2023 is performed. Alternatively, 2022 ay be performed only when the value of the counting information is greater than the threshold of forwarding times. Optionally, 2023 may be performed when the value of the counting information is smaller than or equal to the threshold of forwarding times. Either of the two alternative solutions may be performed according to an actual situation. In the embodiments, 312 is performed following 311, and a sequence of 312 and other steps is not limited. For example, it may be determined whether the value of the counting information is smaller than or equal to the threshold of forwarding times, and if yes, 2022 and 312 are performed. Optionally, if no, 2023 is performed.

To better understand the embodiments, a specific scenario is provided with detailed description.

After the relay receives the data, it is determined whether the value of the counting information is smaller than or equal to the threshold of forwarding times (assumed to be 3). Assuming that in the embodiment, a counting value is 1 before receiving the data, then after receiving the data, the counting value becomes 2 which is smaller than the threshold of forwarding times 3, thus, 2022 is performed, forwarding the data. If the counting value is 3 before receiving the data, after receiving the data, the counting value becomes 4 which is greater than the threshold of forwarding times 3, thus, 2023 is performed, i.e., not forwarding the data.

In the embodiments, whether the data is forwarded can be controlled by limiting the number of forwarding times, which further reduces a resource waste, and improves resource utilization and overall forwarding efficiency.

An embodiment of the present disclosure provides a relay control method, which makes improvement on the method as shown in FIG. 1, where 102 may include determining whether to forward the data based on whether the data forwarded by another relay is received within a first time range.

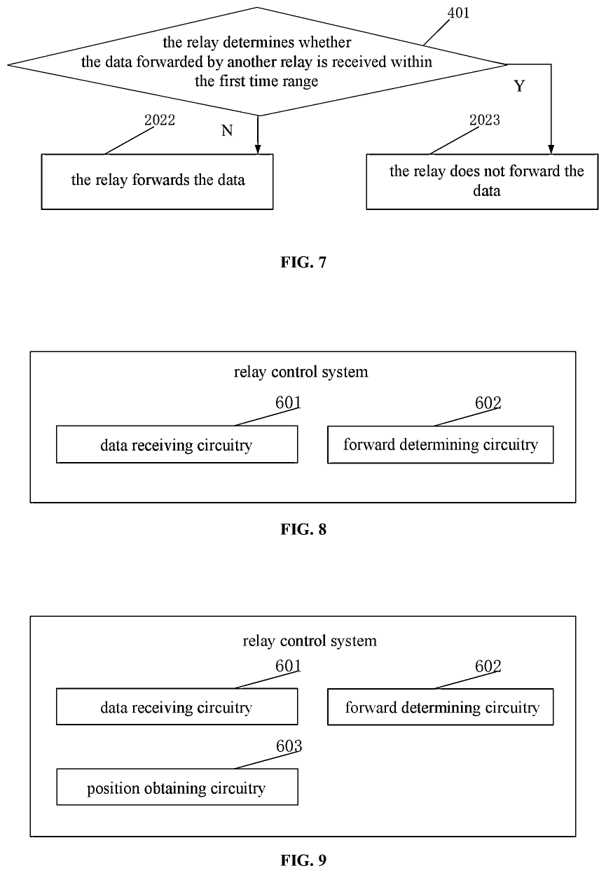

To improve the above step, as shown in FIG. 7, the step may include 401.

In 401, the relay determines whether the data forwarded by another relay is received within the first time range, and if yes, 2022 is performed. Optionally, if no, 2023 is performed.

The first time range may be determined by generating a first random number which is used to represent the first time range. For example, the generated random numbers are 1 to 10, 1 represents 1 second, and 2 represents 2 seconds. If the generated random number is 2, it is necessary to determine whether the data forwarded by another relay is received within 2 seconds, and if not, the relay forwards the data.

In some embodiments, the method further includes: generating a second random number and comparing the second random number with a first random number threshold to determine a value of the first time range. For example, there are two optional first times, one is 0 second, the other is 5 seconds, the first random number threshold is 0.6, and a range of the second random number is 0 to 1. When the generated second random number is smaller than 0.6, the first time range is 0 second, that is, there is no need to determine whether the data forwarded by another relay is received. When the generated first random number is greater than or equal to 0.6, the first time range is 5 seconds. Alternatively, when the generated second random number is smaller than or equal to 0.6, the first time range is 0 second, that is, there is no need to determine whether the data forwarded by another relay is received. When the generated first random number is greater than 0.6, the first time range is 5 seconds, that is, it is necessary to determine whether the data forwarded by another relay is not received within 5 seconds. In this way, the probability of directly forwarding the data (the first time range is 0 second) without determining whether the data forwarded by another relay is received is 60%, and the probability of determining whether the data forwarded by another relay is received within 5 seconds (the first time range is 5 seconds) is 40%.

In some embodiments, the method may further include: if the data forwarded by another relay is received within the first time range, generating a third random number, comparing the third random number with a second random number threshold, and determining whether to forward the data. For example, the second random number threshold is 80%, and the third random number ranges from 0 to 1. When the generated third random number is smaller than 0.8, the data is not forwarded. When the generated third random number is greater than or equal to 0.8, the data is forwarded. Alternatively, When the generated third random number is smaller than or equal to 0.8, the data is not forwarded, and when the generated third random number is greater than 0.8, the data is forwarded. In this way, if the data forwarded by another relay is received within the first time range, the probability of not forwarding the data is 80%, and the probability of forwarding the data is 20%.

In some embodiments, before 2022, it may be further determined whether a distance between the another relay and the relay is longer than or equal to a second preset distance, and if yes, 2022 is performed. Optionally, if no, 2023 is performed. Alternatively, 2022 may be performed only when the distance between the another relay and the relay is longer than the second preset distance. Optionally, 2023 may be performed when the distance between the another relay and the relay is shorter than or equal to the second preset distance.

In the embodiments, when the relay receives the data sent by the first terminal device, it does not simply forward it, but determines whether there is another nearby relay that has already forwarded it. If there is such a nearby relay, the relay needs to determine whether to stop forwarding based on at least one of waiting time, certain probability and distance from other relays, so as to avoid a waste of resources and a conflict.

An embodiment of the present disclosure provides a relay control method. In the foregoing embodiments, the distance between the first terminal device and the relay (denoted as a first determination condition), the number of forwarding times of the data (denoted as a second determination condition), whether the data forwarded by another relay is received within the first time range (denoted as a third determination condition) are used to determine whether the relay should forward the data, respectively. In this embodiment, whether the relay should forward the data is determined based on any combination of the three determination conditions.

When the above-mentioned first determination condition and second determination condition are considered, determining whether to forward the data based on the preset rule includes: only when the distance between the first terminal device and the relay and the number of forwarding times of the data meet the conditions, the data may be forwarded. Optionally, the data is not forwarded in other cases.

When the above-mentioned first determination condition and third determination condition are considered, determining whether to forward the data based on the preset rule includes: only when the distance between the first terminal device and the relay and whether the data forwarded by another relay is received within the first time range meet the conditions, the data may be forwarded. Optionally, the data is not forwarded in other cases.

When the above-mentioned second determination condition and third determination condition are considered, determining whether to forward the data based on the preset rule includes: only when the number of forwarding times of the data and whether the data forwarded by another relay is received within the first time range meet the conditions, the data may be forwarded. Optionally, the data is not forwarded in other cases.

When the above-mentioned first determination condition, second determination condition and third determination condition are considered, determining whether to forward the data based on the preset rule includes: only when the distance between the first terminal device and the relay, the number of forwarding times of the data, and whether the data forwarded by another relay is received within the first time range meet the conditions, the data may be forwarded. Optionally, the data is not forwarded in other cases.

It could be understood that the above-mentioned embodiments may be referred to for determination manners of the first determination condition, the second determination condition, and the third determination condition.

It could be understood that a determination sequence of the above determination conditions may be adjusted arbitrarily.

To better understand the embodiments, a situation of considering all of the first determination condition, the second determination condition and the third determination condition is described in following.

For example, in 2021, if it is determined that the distance between the first terminal device and the relay is longer than or equal to the first preset distance, 301 is performed to determine whether the number of forwarding times of the data is smaller than or equal to the threshold of forwarding times. Merely when the number of forwarding times of the data is smaller than or equal to the threshold of forwarding times, 2022 is performed. Optionally, even if the number of forwarding times of the data is smaller than or equal to the threshold of forwarding times, 401 may be further performed, that is, determining whether the data forwarded by another relay is received within the first time range, if not, 2022 is performed. Optionally, if it is determined in 2021 that the distance between the first terminal device and the relay is shorter than the first preset distance, 2023 is performed. Optionally, if it is determined in 301 that the number of forwarding times of the data is greater than the threshold of forwarding times, 2023 is performed.

An embodiment of the present disclosure provides a relay control system, which is applied to relay. As shown in FIG. 8, the system includes a data receiving circuitry 601 and a forward determining circuitry 602.

The data receiving circuitry 601 is configured to receive data sent by the first terminal device.

The forward determining circuitry 602 is configured to determine whether to forward the data based on a preset rule.

The first terminal device may be either a sender or a relay.

In some embodiments, the relay may be a terminal. The terminal in the embodiments of the present disclosure may refer to various forms of UE, access terminal, user unit, user station, MS, remote station, remote terminal, mobile equipment, user terminal, terminal equipment, wireless communication equipment, user agent or user device. The terminal equipment may further be a cellular phone, a cordless phone, an SIP phone, a WLL station, a PDA, a handheld device with a wireless communication function, a computing device or other processing devices connected to a wireless modems, an in-vehicle device, a wearable device, a terminal equipment in the future 5G network, or a terminal equipment in a future evolved PLAN, which is not limited in the embodiments of the present disclosure.

In the embodiments, the received data is directly forwarded through the terminal device without a base station, which improves a rate and efficiency of data transmission, and increases resource utilization of a communication device.

An embodiment of the present disclosure provides a relay control system which is a further improvement on the embodiment as shown in FIG. 8. As shown in FIG. 9, the system further includes a position obtaining circuitry 603 configured to receive position identification information sent by the first terminal device, wherein the position identification information indicates a position of the first terminal device.

The forward determining circuitry 602 is configured to determine whether to forward the data based on the position identification information of the first terminal device.

In this embodiment, the position obtaining circuitry 603 is configured to obtain the position identification information from received control information, such as SCI, MAC or CE.

The forward determining circuitry 602 is configured to: not forward the data based on that a distance between the first terminal device and the relay is shorter than a preset distance; and/or forward the data based on that the distance between the first terminal device and the relay is longer than the preset distance; and/or forward or not forward the data based on that the distance between the first terminal device and the relay is equal to the preset distance.

In this embodiment, to shorten length of control information carrying the position identification information, the position of the first terminal device may be represented by zone identification information which indicates a position of a zone where the first terminal device is located. It should be understood that a position of the relay may also be represented by zone identification information. In the embodiment, the position is obtained through the zone identifier to reduce a size of the transmitted position identification information, which not only reduces complexity of the control information, but also increases an information transmission rate and saves system resources.

To better understand the embodiment, a specific scenario is provided for detailed description.

The data receiving circuitry 601 controls a second terminal device (a relay) to receive data information sent by a first terminal device (either a relay or a sender), and the data information is associated with control information which is received by the position obtaining circuitry 603 and carries position identification information representing the position of the first terminal device, that is, the position is zone 15. After receiving the data information and the control information associated with the data information sent by the first terminal device, the second terminal device determines via the forward determining circuitry 602 whether a distance between its position, i.e., the zone 14, and the first terminal device is longer than or equal to a preset distance, and if yes, continues to forward the received data to a following terminal device. It should be understood that the following terminal device may be either a receiver or a relay.

In the embodiments of the present disclosure, data is directly forwarded through the relay without a base station, which improves a rate and efficiency of data transmission. In addition, it is determined whether the data needs to be forwarded based on the distance between the first terminal device and the relay, which avoids a conflict between relays due to a close distance and a waste of resources caused by multiple relays with a close distance forwarding the same data, thereby improving a gain of forwarding and resource utilization.

An embodiment of the present disclosure provides a relay control system which is a further improvement on the embodiment as shown in FIG. 8. The forward. determining circuitry 602 is further configured to: determine whether to forward the data based on a number of forwarding times of the data; and forward the data based on that the number of forwarding times of the data is smaller than a threshold of forwarding times, and/or, not forward the data based on that the number of forwarding times of the data is greater than the threshold of forwarding times, and/or, forward or not forward the data based on that the number of forwarding times of the data is equal to the threshold of forwarding times.

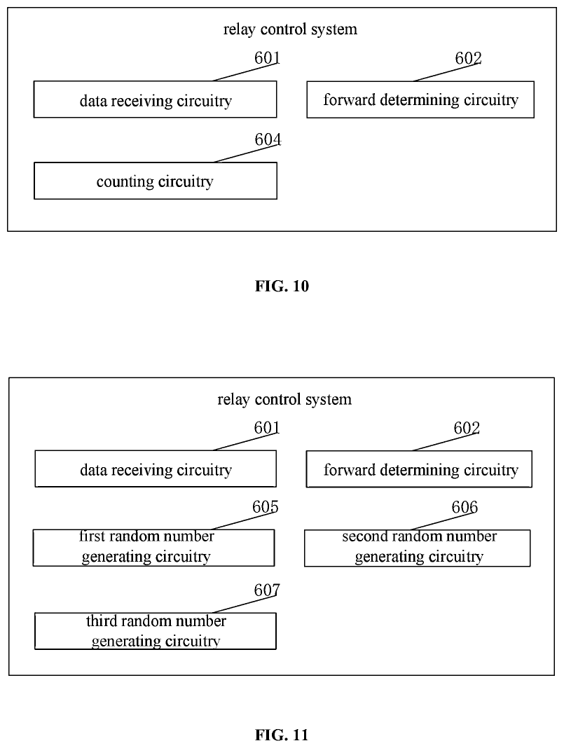

To further optimize the control system, as shown in FIG. 10, the relay control system further includes a counting circuitry 604, configured to receive counting information sent by the first terminal device, wherein the counting information indicates the number of forwarding times of the data.

The counting circuitry 604 is further configured to control a value of the counting information to be added by 1, and the forward determining circuitry 602 is further configured to forward the data based on that the value of the counting information is smaller than the threshold of forwarding times, and/or, not forward the data based on that the value of the counting information is greater than the threshold of forwarding times, and/or, forward or not forward the data based on that the value of the counting information is equal to the threshold of forwarding times, wherein an initial value of the counting information is 0; or the counting circuitry 604 is further configured to control the value of the counting information to be subtracted by 1; and the forward determining circuitry 602 is further configured to forward the data based on that the value of the counting information is greater than 0, and/or, not forward the data based on that the value of the counting information is smaller than 0, and/or, forward or not forward the data based on that the value of the counting information is equal to 0.

After the data receiving circuitry 601 controls the relay to receive the data, the counting circuitry 604 determines whether the value of the counting information is smaller than or equal to the threshold of forwarding times (assumed to be 3). Assuming that in the embodiment, a counting value is 1 before receiving the data, then after receiving the data, the counting value becomes 2 which is smaller than the threshold of forwarding times 3, thus, the forward determining circuitry 602 needs to forward the data. If the counting value is 3 before receiving the data, after receiving the data, the counting value becomes 4 which is greater than the threshold of forwarding times 3, thus, the forward determining circuitry 602 does not need to forward the data.

In the embodiments, whether the data is forwarded can be controlled by limiting the number of forwarding times, which further reduces a resource waste, and improves resource utilization and overall forwarding efficiency.

An embodiment of the present disclosure provides a relay control system which is a further improvement on the embodiment as shown in FIG. 8. The forward determining circuitry 602 is further configured to: not forward the data in response to receiving the data forwarded by another relay within a first time range; and/or, forward the data in response to not receiving the data forwarded by another relay within the first time range.

To determine a value of the first time range, as shown in FIG. 11, the relay control system in the embodiment may further include a first random number generating circuitry 605 configured to generate a first random number which is used to represent the first time range. For example, the generated random numbers are 1 to 10, 1 represents 1 second, and 2 represents 2 seconds. If the generated random number is 2, the forward determining circuitry 602 needs to determine whether the data forwarded by other relay is received within 2 seconds, and if not, forwards the data,

As shown in FIG. 11, in the embodiment, the relay control system may further include a second random number generating circuitry 606 configured to generate a second random number and compare the second random number with a first random number threshold to determine a value of the first time range. For example, there are two optional first times, one is 0 second, the other is 5 seconds, the first random number threshold generated by the first random number generating circuitry 605 is 0.6, and a range of the second random number is 0 to 1. When the generated second random number generated by the second random number generating circuitry 606 is smaller than 0.6, the first time range is 0 second, that is, the forward determining circuitry 602 does not need to determine whether the data forwarded by another relay is received. When the first random number generated by the first random number generating circuitry 605 is greater than or equal to 0.6, the first time range is 5 seconds. Alternatively, when the second random number generated by the second random number generating circuitry 606 is smaller than or equal to 0.6, the first time range is 0 second, that is, the forward determining circuitry 602 does not need to determine whether the data forwarded by another relay is received. When the first random number generated by the first random number generating circuitry 605 is greater than 0.6, the first time range is 5 seconds, that is, the forward determining circuitry 602 does not need to determine whether the data forwarded by another relay is not received within 5 seconds. In this way, the probability of directly forwarding the data (the first time range is 0 second) without determining whether the data forwarded by another relay is received is 60%, and the probability of determining whether the data forwarded by another relay is received within 5 seconds (the first time range is 5 seconds) is 40%.

As shown in FIG. 11, in some embodiments, the system may further include a third random number generating circuitry 607 configured to generate a third random number. If the data forwarded by another relay is received within the first time range, the forward determining circuitry 602 further compares the third random number with a second random number threshold, and determines whether to forward the data. For example, the second random number threshold generated by the second random number generating circuitry 606 is 80%, and the third random number ranges from 0 to 1. When the third random number generated by the third random number generating circuitry 607 is smaller than 0.8, the forward determining circuitry 602 does not forward the data. When the third random number generated by the third random number generating circuitry 607 is greater than or equal to 0.8, the forward determining circuitry 602 forwards the data. Alternatively, when the third random number generated by the third random number generating circuitry 607 is smaller than or equal to 0.8, the forward determining circuitry 602 does not forward the data. When the third random number generated by the third random number generating circuitry 607 is greater than 0.8, the forward determining circuitry 602 forwards the data. In this way, if the data forwarded by another relay is received within the first time range, the probability of not forwarding the data is 80%, and the probability of forwarding the data is 20%.

In some embodiments, the forward determining circuitry 602 is further configured to: in response to receiving the data forwarded by another relay within the first time range, not forward the data based on that a distance between the another relay and the relay is shorter than a preset distance; and/or, forward the data based on that the distance between the another relay and the relay is longer than the preset distance; and/or, forward or not forward the data based on that the distance between the another relay and the relay is equal to the preset distance.

In the embodiments, when the relay receives the data sent by the first terminal device, it does not simply forward it, but determines whether there is another nearby relay that has already forwarded it. If there is such a nearby relay, the relay needs to determine whether to stop forwarding based on at least one of waiting time, certain probability and distance from other relays, so as to avoid a waste of resources and a conflict.

An embodiment of the present disclosure provides a relay control system. In the foregoing embodiments, the distance between the first terminal device and the relay (denoted as a first determination condition), the number of forwarding times of the data (denoted as a second determination condition), whether the data forwarded by another relay is received within the first time range (denoted as a third determination condition) are used to determine whether the relay should forward the data, respectively. In this embodiment, Whether the relay should forward the data is determined by the forward determining circuitry 602 based on any combination of the three determination conditions.

When the above-mentioned first determination condition and second. determination condition are considered, the forward determining circuitry 602 forwards the data only when the distance between the first terminal device and the relay and the number of forwarding times of the data meet the conditions. Optionally, the data is not forwarded in other cases.

When the above-mentioned first determination condition and third determination condition are considered, the forward determining circuitry 602 forwards the data only when the distance between the first terminal device and the relay and whether the data forwarded by another relay is received within the first time range meet the conditions. Optionally, the data is not forwarded in other cases.

When the above-mentioned second determination condition and third determination condition are considered, the forward determining circuitry 602 forwards the data only when the number of forwarding times of the data and whether the data forwarded by another relay is received within the first time range meet the conditions. Optionally, the data is not forwarded in other cases.

When the above-mentioned first determination condition, second determination condition and third determination condition are considered, the forward determining circuitry 602 forwards the data only when the distance between the first terminal device and the relay, the number of forwarding times of the data, and whether the data forwarded by another relay is received within the first time range meet the conditions. Optionally, the data is not forwarded in other cases,

It could be understood that the above-mentioned embodiments may be referred to for determination manners of the first determination condition, the second determination condition, and the third determination condition.

It could be understood that a determination sequence of the above determination conditions may be adjusted arbitrarily.

To better understand the embodiments, a situation of considering all of the first determination condition, the second determination condition and the third determination condition is described in following.

For example, if the forward determining circuitry 602 determines that the distance between the first terminal device and the relay is longer than or equal to the first preset distance, it further determines whether the number of forwarding times of the data is smaller than or equal to the threshold of forwarding times. Merely when the number of forwarding times of the data is smaller than or equal to the threshold of forwarding times, the forward determining circuitry 602 forwards the data. Optionally, even if the number of forwarding times of the data is smaller than or equal to the threshold of forwarding times, it may be further determined whether the data forwarded by another relay is received within the first time range, if not, the data is forwarded. Optionally, if the forward determining circuitry 602 determines that the distance between the first terminal device and the relay is shorter than the first preset distance, the data does not need to be forwarded. Optionally, if the forward determining circuitry 602 determines that the number of forwarding times of the data is greater than the threshold of forwarding times, the data does not need to be forwarded.

An embodiment of the present disclosure provides an electronic device, which may be in a form of a computing device (for example, a server device), including a memory, a processor, and a computer program stored on the memory and capable of running on the processor, wherein when the processor executes the computer program, any one of the relay control methods in the above embodiments is performed.

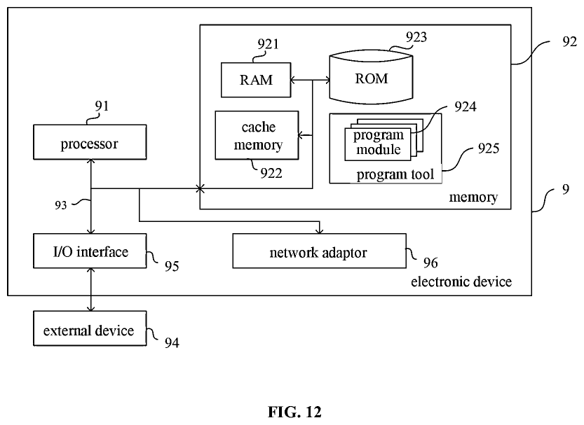

FIG. 12 illustrates a schematic diagram of a hardware structure in the embodiment. As shown in FIG. 12, the electronic device 9 specifically includes at least one processor 91, at least one memory 92, and a bus 93 for connecting different system components including the processor 91 and the memory 92.

The bus 93 includes a data bus, an address bus, and a control bus.

The memory 92 includes a volatile memory, such as a Random Access Memory (RAM) 921 and/or a cache memory 922, and may further include a Read Only Memory (ROM) 923.

The memory 92 further includes a program tool 925 having a set (at least one) of program modules 924 including, but not limited to, an operating system, one or more application programs, other program modules, and program data, each or some combination of which may include implementation of network environment.

The processor 91 executes the computer program stored in the memory 92 to perform various function applications and data processing, such as any of the relay control methods in the above embodiments.

The electronic device 9 may further communicate with one or more external devices 94 (e.g., keyboards, pointing devices). Such communication may be performed through Input/Output (I/O) interface 95. In addition, the electronic device 9 can also communicate with one or more networks (such as a Local Area Network (LAN), a Wide Area Network (WAN) and/or a public network such as the Internet) through a network adapter 96 which communicates with other modules of the electronic device 9 via the bus 93. It could be understood that although not shown in the figures, other hardware and/or software modules may be used in conjunction with the electronic device 9, including but not limited to microcode, device drivers, redundant processors, external disk drive arrays, Redundant Arrays of Independent Disks (RAID) systems, tape drivers, and data backup storage systems.

It should be noted that although several units modules or subunits/sub-modules of the electronic device are mentioned in the above detailed description, such division is only exemplary and not mandatory. Actually, according to the embodiments of the present disclosure, the features and functions of two or more units/modules described above may be embodied in one unit/module. Conversely, the features and functions of one unit/module described above can be further divided to be embodied by a plurality of units/modules.

An embodiment of the present disclosure provides a computer-readable storage medium, on which a computer program is stored. When the program is executed by a processor, steps of any one of the relay control methods in the above embodiments are performed.

The computer-readable storage medium may include but is not limited to portable disk, hard disk, random access memory, read-only memory, erasable programmable read-only memory, optical storage device, magnetic storage device, or any suitable combination of these.

In some embodiments, a program product is provided, which includes program codes, and when the program product runs on a terminal device, the program code makes the terminal device execute any one of the relay control methods in the above embodiments.

The program code for executing the present disclosure may be written in any combination of one or more programming languages, and the program code may be completely executed on a user equipment, partially executed on the user equipment, executed as an independent software package, executed partially on the user equipment and partially on a remote device, or executed entirely on the remote device.

The technical solutions of the present disclosure can be applied to 5G communication systems, 4G and 3G communication systems, and various new communication systems in the future, such as 6G and 7G communication systems.

The technical solutions of the present disclosure also can be applied to different network architectures, including but not limited to a relay network architecture, a dual-link architecture, and a vehicle-to-everything architecture.

In the embodiments of the present disclosure, a core network may be an Evolved Packet Core (EPC), 5G Core Network or a new core network in future communication systems. The 5G Core Network is composed of a set of devices, implements Access and Mobility Management Function (AMF) providing functions such as mobility management function, User Plane Function (UPF) providing functions such as packet routing and forwarding and Quality of Service (QoS) management, and Session Management Function (SMF) providing functions such as session management and IP address allocation and management. EPC can be composed of MME that provides functions such as mobility management and gateway selection, Serving Gateway (S-GW) that provides functions such as data packet forwarding, and PDN Gateway (P-GW) that provides functions such as terminal address allocation and rate control.

The Base Station (BS) in the embodiments of the present disclosure may also be referred to as a base station equipment, and is an apparatus deployed in a wireless access network to provide wireless communication functions. For example, an equipment that provides a base station function in a 2G network includes a Base Transceiver Station (BTS). An equipment that provides the base station function in a 3G network includes a Node B. An equipment that provides the base station function in a 4G network includes an evolved Node B (eNB). In a Wireless Local Area Network (WLAN), an equipment that provides the base station function is an Access Point (AP). An equipment that provides the base station function in 5G New Radio (NR) includes a gNB and an ng-eNB, where the gNB and the terminal use NR technology to communicate, and the ng-eNB and the terminal use Evolved Universal Terrestrial Radio Access (E-UTRA) technology to communicate. Both the gNB and the ng-eNB can be connected to a 5G core network. The base station also refers to an equipment that provides the base station function in a new communication system in the future.

The base station controller in the embodiments of the present disclosure is a device for managing base stations, such as a Base Station Controller (BSC) in a 2G network, a Radio Network Controller (RNC) in a 3G network, or a device that controls and manages a base station in a new communication system in the future.

The network in the embodiments of the present disclosure refers to a communication network that provides communication services for terminals, including a base station of a radio access network, a BSC of a radio access network, and a device on the core network.

It could be understood that the term “and/or” in the present disclosure is merely an association relationship describing associated objects, indicating that there can be three types of relationships, for example, A and/or B can represent “A exists only, both A and B exist, B exists only. In addition, the character “/” in the present disclosure represents that the former and latter associated objects have an “or” relationship.

The “plurality” in the embodiments of the present disclosure refers to two or more.

The descriptions of the first, second, etc. in the embodiments of the present disclosure are merely for illustrating and differentiating the objects, and do not represent the order or the particular limitation of the number of devices in the embodiments of the present disclosure, which do not constitute any limitation to the embodiments of the present disclosure.

The “connection” in the embodiments of the present disclosure refers to various connection ways such as direct connection or indirect connection to realize communication between devices, which is not limited in the embodiments of the present disclosure.

In the embodiments of the present disclosure, the processor may be a Central Processing Unit (CPU), or other general processors, Digital Signal Processors (DSPs), Application Specific Integrated Circuits (ASICs), Field Programmable Gate Arrays (FPGAs) or other Programmable logic devices, discrete gates or transistor logic devices, discrete hardware components, and the like. A general processor may be a microprocessor or the processor may be any conventional processor or the like.

It should also be understood that the memory in the embodiments of the present disclosure may be either volatile memory or nonvolatile memory, or may include both volatile and nonvolatile memories. The non-volatile memory may be a Read-Only Memory (ROM), a Programmable ROM (PROM), an Erasable PROM (EPROM), an electrically Erasable EPROM (EEPROM), or a flash memory. The volatile memory may be a Random Access Memory (RAM) which functions as an external cache. By way of example but not limitation, various forms of RAM are available, such as Static Random Access Memory (SRAM), Dynamic Random Access Memory (DRAM), Synchronous Dynamic Random Access Memory (SDRAM), Double Data Rate Synchronous Dynamic Random Access Memory (DDR SDRAM), Enhanced SDRAM (ESDRAM), Synchronous connection to DRAM (SLDRAM), and Direct Rambus RAM (DR-RAM).

The above embodiments may be implemented in whole or in part by software, hardware, firmware or any combination thereof. When implemented in software, the above embodiments may be implemented in whole or in part in the form of a computer program product. The computer program product includes one or more computer instructions or computer programs. The procedures or functions according to the embodiments of the present disclosure are wholly or partially generated when the computer instructions or the computer programs are loaded or executed on a computer. The computer may be a general purpose computer, a special purpose computer, a computer network, or other programmable device. The computer instructions may be stored in a computer readable storage medium or transmitted from one computer readable storage medium to another computer readable storage medium, for example, the computer instructions may be transmitted from one website, computer, server or data center to another website, computer, server or data center by wire (e.g., infrared, wireless, microwave and etc.). The computer readable storage medium may be any available medium that can be accessed by a computer or a data storage device such as a server or a data center that contains one or more sets of available media. The available medium may be a magnetic medium (e.g., floppy disk, hard disk or magnetic tape), an optical medium (e.g., DVD), or a semiconductor medium. The semiconductor medium may be a solid disk.

It should be understood that, in the various embodiments of the present disclosure, sequence numbers of the above-mentioned processes do not represent an execution sequence, and the execution sequence of each process should be determined by its function and inherent logic, which does not limit an implementation process of the embodiments of the present disclosure.

In the above embodiments of the present disclosure, it should be understood that the disclosed method, device and system may be implemented in other ways. For example, the above device embodiments are merely illustrative, and for example, division of units is merely one logical division, and other divisions may be realized in practice, for example, a plurality of units or components may be combined or integrated into another system, or some features may be omitted, or not executed. Further, the shown or discussed mutual coupling or direct coupling or communication connection may be an indirect coupling or communication connection via some interfaces, devices or units, and may be in an electrical, mechanical or other form.

The units described as separate parts may or may not be physically separate, and parts shown as units may or may not be physical units, that is, may be disposed in one place, or may be distributed on a plurality of network units. Some or all of the units can be selected according to practical requirements to achieve the purpose of the solutions of the embodiments.

In addition, functional units in the embodiments of the present disclosure may be integrated in one processing unit, or each unit may be physically separate, or two or more units may be integrated in one unit. The integrated units can be realized in a form of hardware, or in a form of hardware plus a software functional unit.

The integrated units implemented in the form of the software functional unit may be stored in a computer readable storage medium. The software functional unit is stored in a storage medium and includes several instructions for causing a computer device (a personal computer, a server or a network device) to execute some steps of the methods in the embodiments of the present disclosure. And the storage medium may be a medium for storing program codes, such as a U disk, a removable hard disk, a ROM, a RAM, a magnetic disk or an optical disk.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure, which includes any combinations of the above different functions and embodiment steps, and implementing ways of software and hardware.

Although the embodiments of the present disclosure are described, those skilled in the art could understand that this is only an illustration, and the scope of the present disclosure is limited by the appended claims. Those skilled in the art may make a variety of changes or modifications to these embodiments without deviating from principles and essence of the present disclosure, while these changes and modifications fall within the scope of the present disclosure.

In the claims:

1. A relay control method, applied to a relay and comprising:
receiving data sent by a first terminal device; and
determining whether to forward the data based on a preset rule.

2. The method according to claim 1, further comprising:
receiving position identification information sent by the first terminal device, wherein the position identification information indicates a position of the first terminal device,
wherein said determining whether to forward the data based on a preset rule comprises: determining whether to forward the data based on the position identification information of the first terminal device.

3. The method according to claim 2, wherein said determining whether to forward the data based on the position identification information of the first terminal device comprises:
not forwarding the data based on that a distance between the first terminal device and the relay is shorter than a preset distance; and/or
forwarding the data based on that the distance between the first terminal device and the relay is longer than the preset distance; and/or
forwarding or not forwarding the data based on that the distance between the first terminal device and the relay is equal to the preset distance.

4. The method according to claim 2, wherein the position identification information comprises zone identification information which indicates a position of a zone where the first terminal device is located.

5. The method according to claim 1, wherein said determining whether to forward the data based on a preset rule comprises:
determining whether to forward the data based on a number of forwarding times of the data; and
forwarding the data based on that the number of forwarding times of the data is smaller than a threshold of forwarding times, and/or, not forwarding the data based on that the number of forwarding times of the data is greater than the threshold of forwarding times, and/or, forwarding or not forwarding the data based on that the number of forwarding times of the data is equal to the threshold of forwarding times.

6. The method according to claim 5, further comprising:
receiving counting information sent by the first terminal device, wherein the counting information indicates the number of forwarding times of the data.

7. The method according to claim 6, wherein said determining whether to forward the data based on a number of forwarding times of the data comprises:
controlling a value of the counting information to be added by 1, an initial value of the counting information being 0; and forwarding the data based on that the value of the counting information is smaller than the threshold of forwarding times, and/or, not forwarding the data based on that the value of the counting information is greater than the threshold of forwarding times, and/or, forwarding or not forwarding the data based on that the value of the counting information is equal to the threshold of forwarding times; or
controlling the value of the counting information to be subtracted by 1; and forwarding the data based on that the value of the counting information is greater than 0, and/or, not forwarding the data based on that the value of the counting information is smaller than 0, and/or, forwarding or not forwarding the data based on that the value of the counting information is equal to 0.

8. The method according to claim 1, wherein said determining whether to forward the data based on a preset rule comprises:
not forwarding the data in response to receiving the data forwarded by another relay within a first time range; and/or,
forwarding the data in response to not receiving the data forwarded by another relay within the first time range.

9. The method according to claim 8, further comprising:
generating a first random number which indicates the first time range; and/or,
generating a second random number, comparing the second random number with a first random number threshold, and determining a value of the first time range; and/or,
generating a third random number, comparing the third random number with a second random number threshold, and determining whether to forward the data.

10. The method according to claim 8, wherein in response to receiving the data forwarded by another relay within the first time range, the method further comprises:
not forwarding the data based on that a distance between the another relay and the relay is shorter than a preset distance; and/or,
forwarding the data based on that the distance between the another relay and the relay is longer than the preset distance; and/or,
forwarding or not forwarding the data based on that the distance between the another relay and the relay is equal to the preset distance.

11-20. (canceled)

21. An electronic device, comprising a memory and a processor, wherein the memory stores one or more programs, the one or more programs comprising computer instructions, which, when executed by the processor, cause the processor to:
receive data sent by a first terminal device; and
determine whether to forward the data based on a preset rule.

22. A non-transitory computer-readable storage medium storing one or more programs, the one or more programs comprising computer instructions, which, when executed by a processor, cause the processor to:
receive data sent by a first terminal device; and
determine whether to forward the data based on a preset rule.

23. The electronic device according to claim 21, wherein the processor is further caused to:
receive position identification information sent by the first terminal device, wherein the position identification information indicates a position of the first terminal device; and
determine whether to forward the data based on the position identification information of the first terminal device.

24. The electronic device according to claim 23, wherein the processor is further caused to:
not forward the data based on that a distance between the first terminal device and the relay is shorter than a preset distance; and/or
forward the data based on that the distance between the first terminal device and the relay is longer than the preset distance; and/or
forward or not forward the data based on that the distance between the first terminal device and the relay is equal to the preset distance.

25. The electronic device according to claim 23, wherein the position identification information comprises zone identification information which indicates a position of a zone where the first terminal device is located.

26. The electronic device according to claim 21, wherein the processor is further caused to:
determine whether to forward the data based on a number of forwarding times of the data; and
forward the data based on that the number of forwarding times of the data is smaller than a threshold of forwarding times, and/or, not forward the data based on that the number of forwarding times of the data is greater than the threshold of forwarding times, and/or, forward or not forward the data based on that the number of forwarding times of the data is equal to the threshold of forwarding times.

27. The electronic device according to claim 26, wherein the processor is further caused to:
receive counting information sent by the first terminal device, wherein the counting information indicates the number of forwarding times of the data.

28. The electronic device according to claim 27, wherein the processor is further caused to:
control a value of the counting information to be added by 1, an initial value of the counting information being 0; and forward the data based on that the value of the counting information is smaller than the threshold of forwarding times, and/or, not forward the data based on that the value of the counting information is greater than the threshold of forwarding times, and/or, forward or not forward the data based on that the value of the counting information is equal to the threshold of forwarding times; or
control the value of the counting information to be subtracted by 1; and forward the data based on that the value of the counting information is greater than 0, and/or, not forward the data based on that the value of the counting information is smaller than 0, and/or, forward or not forward the data based on that the value of the counting information is equal to 0.

29. The electronic device according to claim 21, wherein the processor is further caused to:
not forward the data in response to receiving the data forwarded by another relay within a first time range; and/or,
forward the data in response to not receiving the data forwarded by another relay within the first time range.

30. The electronic device according to claim 29, wherein the processor is further caused to:
generate a first random number which indicates the first time range; and/or,
generate a second random number, compare the second random number with a first random number threshold, and determine a value of the first time range; and/or,
generate a third random number, compare the third random number with a second random number threshold, and determine whether to forward the data.
